(19) United States
(12) Patent Application Publication
(10) Pub. No.: US 2022/0266065 A1
(43) Pub. Date: Aug. 25, 2022

(54) PREFABRICATED RETROFIT STACKABLE AND ATTACHABLE ESCAPE TOWER

(71) Applicant: Prescape Towers, Ltd., Hertsfordshire (GB)

(72) Inventor: KEVIN STEWART, Hertsfordshire (GB)

(73) Assignee: Prescape Towers, Ltd., Hertsfordshire (GB)

(21) Appl. No.: 17/633,385

(22) PCT Filed: Aug. 7, 2020
(86) PCT No.: PCT/IB20/00653

§ 371 Date: Feb. 7, 2022

Related U.S. Application Data
(60) Provisional application No. 62/884,050, filed on Aug. 7, 2019.

(51) Int. Cl. A62B 1/20; E04B 1/348; E04H 1/00

(52) U.S. Cl. CPC A62B 1/20; E04B 1/3483; E04H 1/005; E04B 2001/34892

(57) ABSTRACT

Multi-story retrofitting building escape units. In aspects, the units are prefabricated and may be stacked. In embodiments, water or other fire-deterrent liquid or foam may be stored or delivered in tubular legs of the unit or tubes with in the legs. A hose or other mechanism to apply the water or other liquid is located in one more units. Each unit comprises stairs that link up with stairs on units above or below so occupants can climb down, for example, and emergency personnel can climb up, for example. In aspects, one or more walls of the unit are fire walls or otherwise fire-retardant, fire-proof, or fire-resistant.

### CROSS-REFERENCE TO RELATED APPLICATIONS

The present application is a U.S. National Stage Application of PCT/IB2020/000653, filed Aug. 7, 2020, which relies on the disclosures of and claims priority to and the benefit of the filing date of U.S. Provisional Application No. 62/884,050, filed Aug. 7, 2019. The disclosures of those applications are hereby incorporated by reference herein in their entireties.

### BACKGROUND OF THE INVENTION

### Field of the Invention

Grenfell Tower was a 24-story residential tower block in North Kensington in London, England, the remains of which are still standing following a fire in June of 2017. The tower was completed in 1974. The building's top 20 floors consisted of 120 flats, with six per floor—two flats with one bedroom each and four flats with two bedrooms each—with a total of 200 bedrooms. Its first four floors were non-residential until its most recent refurbishment, from 2015 to 2016, when two of them were converted to residential use, bringing it up to 127 flats and 227 bedrooms; six of the new flats had four bedrooms each and one flat had three bedrooms.

The fire caused severe damage to the building and killed 72 people. It is believed to have started on the fourth floor, before it quickly spread to the whole building. At least 350 people were thought to be inside when the blaze began, and some were still trapped hours later. The rapid spread has been attributed to the building's cladding, which is a type in widespread use, along with the external insulation. It burned for about 60 hours before finally being extinguished.

The current invention relates to a permanent or temporary retrofitting system and apparatus that can be installed adjacent to a building to provide for fire safety, including a way for occupants to flee a fire or other emergency, for emergency personnel to gain entry to the building, and in cases for ways to treat a fire; the apparatus and system allow for the invention to work on multistory buildings, like the tragic Grenfell Tower.

### Description of the Related Art

Since the deadly fire, authorities have tested more than 120 high-rise buildings in the United Kingdom in dozens of areas across Britain and found that all were fitted with external cladding panels that failed safety fire tests. It is believed that this tragic event which took place in the United Kingdom has brought to light a major safety risk for other such buildings around the world.

Consequently, there is a need for a means to retrofit/attach to existing high-rise buildings around the world a mechanism to provide a way for occupants to escape such buildings should a fire or other emergency to occur.

### SUMMARY OF THE INVENTION

In one embodiment of the present invention, a pod or unit (pod or unit is used interchangeably herein) is provided that can be designed such that each pod, comprises, by way of example only: a door to a floor, story, or other location of an adjacent building to which it is associated; a door or opening to adjacent pods, such as pods stacked above and below; and combinations thereof. In aspects, a pod can be designed such that the pod comprises, by way of example only, an exhaust fan, a window, a connecting member, a support member, a hollow connecting support member, a light, a communication system, stairs, a slide or shoot, a hose, oxygen supply or mechanism to supply oxygen, a water or other liquid reservoir, a water or other liquid storage container, a tube or other mechanism to supply water or other liquid, a sprinkler system, a water sprinkler, a pump, an adjacent pod (such as a pod stacked above or below), and combinations thereof. In aspects, a pod or group of pods is capable of supporting a water reservoir, a water container, or a container holding water, another liquid, foam, or another material. Doors to an adjacent building or between pods, as well as walls, floors, ceilings, and other aspects comprising the pod, may be fire-retardant, fire proof, and/or fire resistant. In aspects, a pod can be made of, for example, concrete, metal, treated or reinforced plastic, ceramic, glass, and combinations thereof In aspects, a design of a pod may be a rounded design, an oval design, a square design, a rectangular design, or other shaped design.

In particular embodiments, a tower (e.g., a tower of pods stacked upon each other) may comprise a water (or other liquid or foam) storage reservoir, which in aspects is placed at the top of the tower, which can be, by way of example only, around 45 cubic meters and stored in one, two, or more compartments comprising one, two, or more fire pumps, and in cases automatic fire pumps. In cases, one pump is a main pump and one or more is a back-up pump. In embodiments, there can be a breeching unit/inlet fitted on the ground level to enable a fire brigade, fire department, or other emergency service, to fill the wet riser tank remotely.

### BRIEF DESCRIPTION OF THE DRAWINGS

The accompanying drawings illustrate certain aspects of some of the embodiments of the present invention, and should not be used to limit or define the invention. Together with the written description the drawings serve to explain certain principles of the invention.

FIG. 1 is a schematic diagram of a depiction of one possible embodiment of a unit/pod taught herein.

FIG. 2 is a schematic diagram of a depiction of one possible embodiment of a unit/pod taught herein.

FIG. 3 is a schematic diagram of a depiction of one possible embodiment of a unit/pod taught herein.

FIG. 4 is a schematic diagram of a depiction of one possible embodiment of the system/apparatus taught herein, including units/pods stacked on top of each other.

FIG. 5 is a schematic diagram of a depiction of one possible embodiment of a unit/pod taught herein.

FIG. 6 is a schematic diagram of a depiction of one possible embodiment of a unit/pod taught herein.

FIG. 7 is a schematic diagram of a depiction of one possible embodiment of a unit/pod taught herein.

### DETAILED DESCRIPTION OF VARIOUS EMBODIMENTS OF THE INVENTION

The present invention has been described with reference to particular embodiments having various features. It will be apparent to those skilled in the art that various modifications and variations can be made in the practice of the present invention without departing from the scope or spirit of the invention. One skilled in the art will recognize that these features may be used singularly or in any combination based on the requirements and specifications of a given application or design. Embodiments comprising various features may also consist of or consist essentially of those various features. Other embodiments of the invention will be apparent to those skilled in the art from consideration of the specification and practice of the invention. The description of the invention provided is merely exemplary in nature and, thus, variations that do not depart from the essence of the invention are intended to be within the scope of the invention. All references cited in this specification are hereby incorporated by reference in their entireties.

The invention herein is directed to multi-story retrofitting escape units. In aspects, the units are prefabricated and delivered to an installation site. The units may be stacked and in cases bolted or otherwise affixed together, one on top of the other. The units may be stacked so that two units, three units, four units, five units, and so on are stacked together (in aspects, vertically, horizontally, or diagonally). In embodiments, water or other fire-deterrent liquid (or foam or other material) may be stored in tubular or hollowed-out legs of the unit, and a hose or sprinkler or other mechanism to apply the water or other liquid to a fire are connected to the storage portions; for example, a water hose and/or water hose reel may be mounted at every floor level or every unit, or one or more stacked units. In aspects, pressure is delivered so that the water or other liquid can be sprayed or otherwise applied to a fire, in cases delivering up to one bar of pressure, two bars, three bars, four bars, five bars, six bars, seven bars, eight bars, and so on. In certain aspects a watertight gasket is located on the bottom and/or top of one or more tubular legs of the unit. In aspects, each unit comprises a door, such as a fire door, allowing for safe escape for building occupants or for access to emergency personnel at, for example, each level of a building. Each unit comprises stairs that meet and/or link up with stairs on units above or below so occupants can climb down, for example, and emergency personnel can climb up, for example. In aspects, one or more walls of the unit are fire walls or otherwise fire-retardant, fire-resistant, or fire-proof.

In embodiments, the units may be erected adjacent to a multistory building and, in embodiments, without any additional scaffolding needed to be added to the units for support or otherwise. For example, a contractor or builder can create permanent or temporary access through to existing walls or doors (of, for example, an adjacent building) once units are installed. The units may in examples be installed from the ground up to any level or story of a building, including by stacking units on top of each other. In aspects, a base unit can be prepared to be suitable to provide a foundation or foundational support for the units stacked above it. In aspects, units lower in a stack or tower may provide for more support compared to units higher in the stack or tower. In aspects, the units are manufactured/designed so that additional support can be readily added to a unit depending on support needs of the unit or the stack or tower as a whole.

In particular embodiments, steel, or other metal, tubes, for example rounded (e.g., circular) or with flat sides (e.g., square or rectangular), may be included to suit local or regional building requirements and regulatory approval.

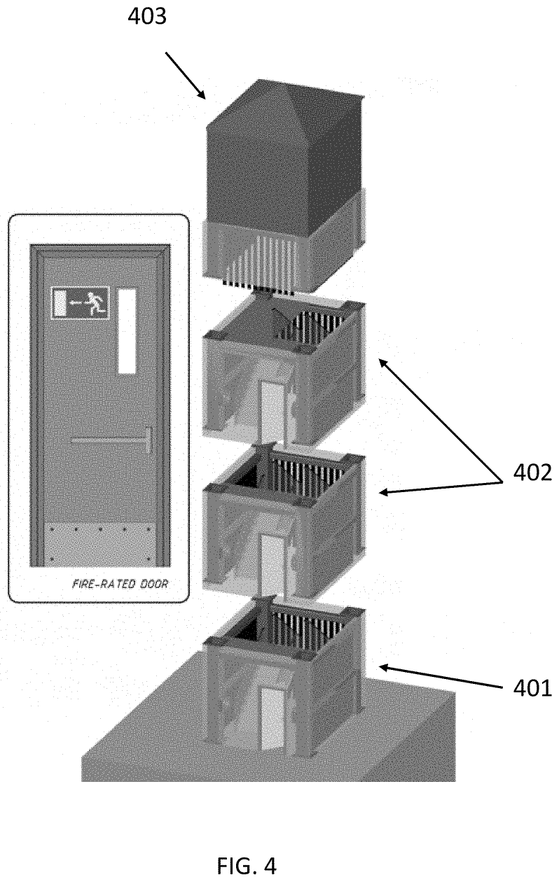

As shown in FIG. 4, the units or pods may be stacked on top of each other. In embodiments, at the bottom of the stack, is a base starter pod, which may have additional foundational support or reinforcements to form a base for the pod stack. In embodiments, at the top of the stack, a water (or other liquid, foam, or other material) storage unit is located, wherein pressure or other force would be directed downwards to lower pods, for example through tubes in or near one or more of the units' legs. Therefore, at each level or each pod, water or other liquid/foam may be stored or accessed or readily available. For example, in each pod, there may be included a fire hose wherein water or other liquid from the water storage pod is accessed and due to the pressure or other force may be dispensed from the hose to spray or otherwise apply to a fire. In other aspects, there may be included a sprinkler system at every level or every unit, as well as a control valve in aspects. Due to the water pressure or force from the water storage pod for example, the sprinkler system could be in every pod or even be extended into the building itself In other aspects of the invention, a pump(s), such as an electric pump(s) could be used to provide water pressure to the fire hose or sprinkler system, and, in such cases, an elevated water storage pod would not be required; for example, water could be pumped up to units. In other embodiments, water or other liquid/foam storage containers are located in, on, or near each unit, or between units, such as at every other unit, every two units, every three units, and so on, in a stack, for example. Herein, when water is referred to, water may also be replaced with any other liquid, foam, or other substance, including substances for fighting fires.

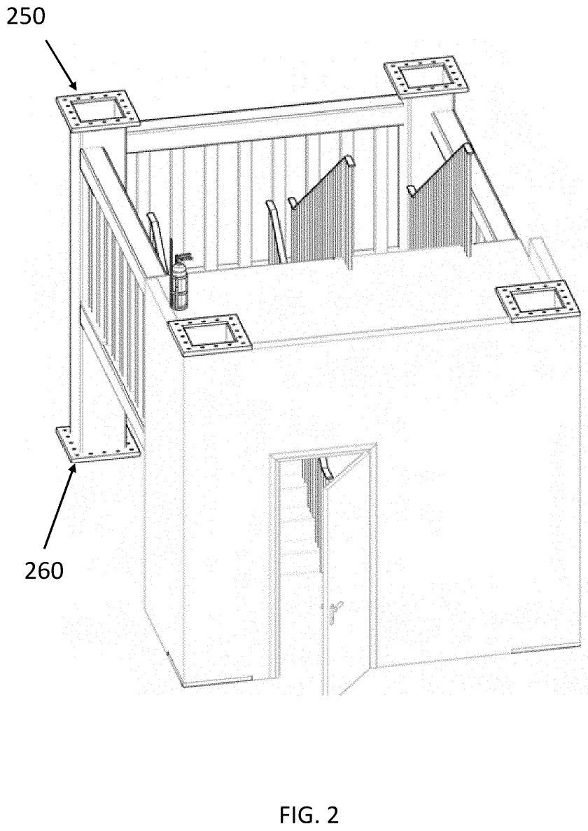

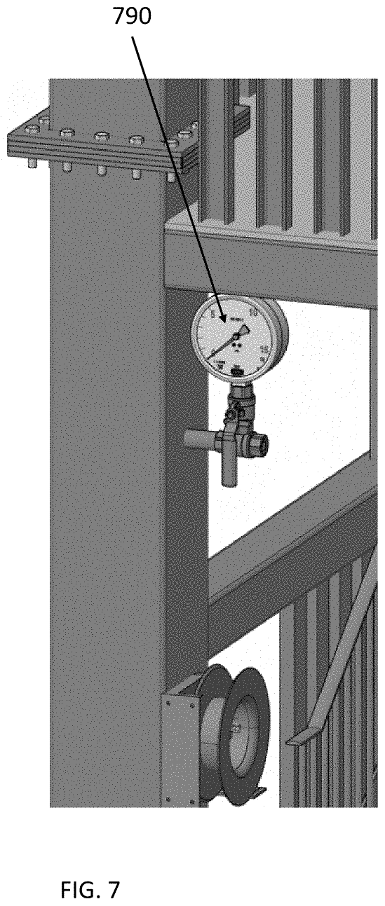

FIG. 7 shows a possible embodiment wherein control sprinkler valves are located on one or more units stacked together that provide a sprinkler system for the pods or to be extended into the building. In aspects, watertight joints are included at the legs between each level where tubes for water or other liquid may be located, thereby creating a network of water supply between stacked units, including from top to bottom. In FIG. 2, for example, all pods may be connected together from inside so that no additional scaffolding is necessary or required to erect the stacked unit tower.

In embodiments, each unit, or some units in a stack, may include a door, for example an emergency exit door so building occupants can access the units and the stairs therein, or emergency personnel can access the interior of the building. In aspects that include an elevated water storage pod, the water reservoir therein would supply water (or other liquid) to hoses and/or hose reels in the units, such as via a regulation control valve(s). FIG. 4 shows units stacked on top of one another, adjacent to a building, with a base foundational unit and a water storage unit at the top.

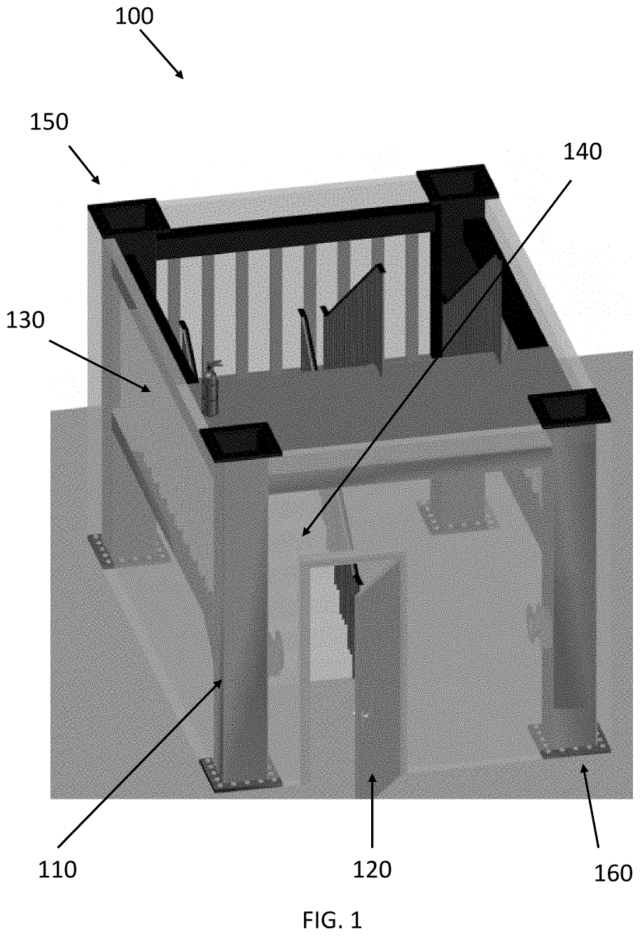

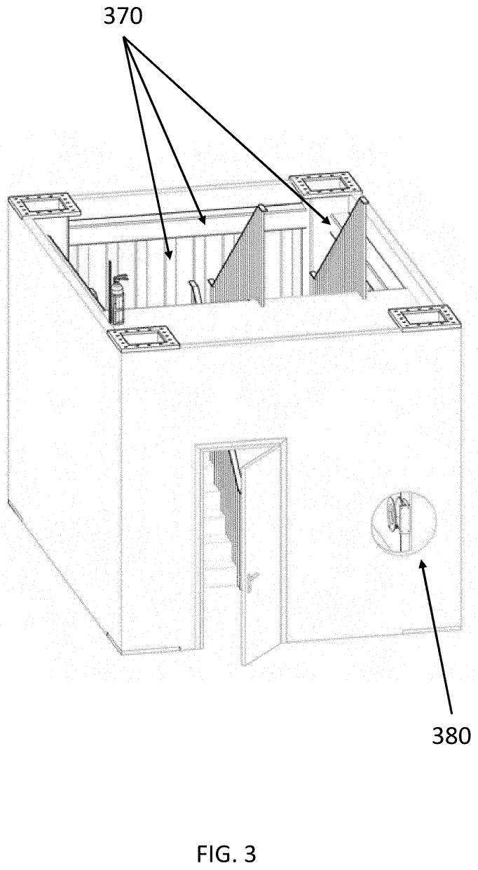

Turning to particular figures more specifically, FIG. 1 shows an embodiment of a unit 100, including four supporting legs 110, one or more of which, in aspects, are hollow or tubular or comprise tubes for storing or transporting water or other liquid, which may be supplied to a hose, sprinkler system, or combinations thereof In this embodiment a door 120 is shown that may provide ingress and egress to a building adjacent to the unit. The walls 130 may be fire-retardant, fire-resistant, or fire-proof in order to protect the inside of the unit and the unit itself from fire and fire-induced damage. In this embodiment, stairs 140 are shown that provide a way for occupants of the building to climb down in the case of a fire or other emergency, or for emergency to climb up and down in the case of a fire or other emergency. The tops of the legs 150 may be designed for linking or otherwise attaching to or connecting to a unit stacked above, and the bottoms of the legs 160 may be designed to link or otherwise attach to a unit below. In cases, the connections between the unit legs may be watertight so water or other liquid can travel between units. In FIG. 2, the connections on top 250 and bottom 260 are shown and they may in examples comprise watertight gaskets and be bolted or otherwise affixed to units above and below. In FIG. 3, walls are shown as well as examples of steel tubes or beams 370 that can be used to further support the unit. In examples, these can be circular, square, rectangular, or other shaped beams or tubes to support the structure and in some cases may carry or store water or other liquid. In FIG. 3, a fire hose and/or fire hose reel are shown 380, which may be supplied with water or other liquid stored in the unit, supplied from below along with pumped force, or supplied from above, by, for example, a water pod or container pod stacked above.

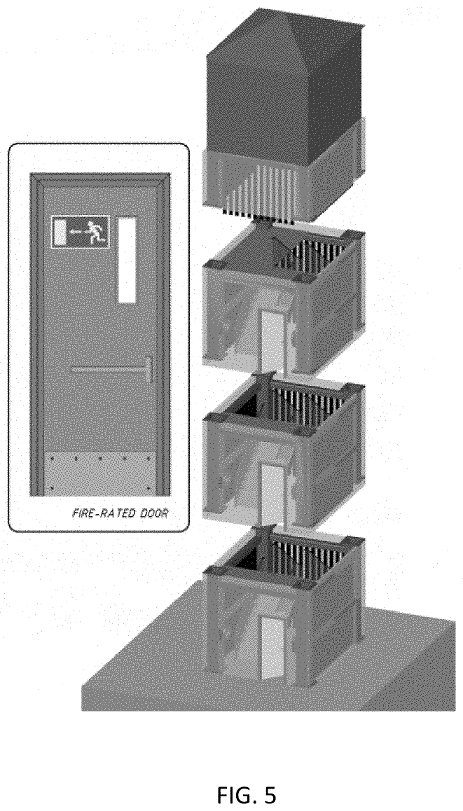

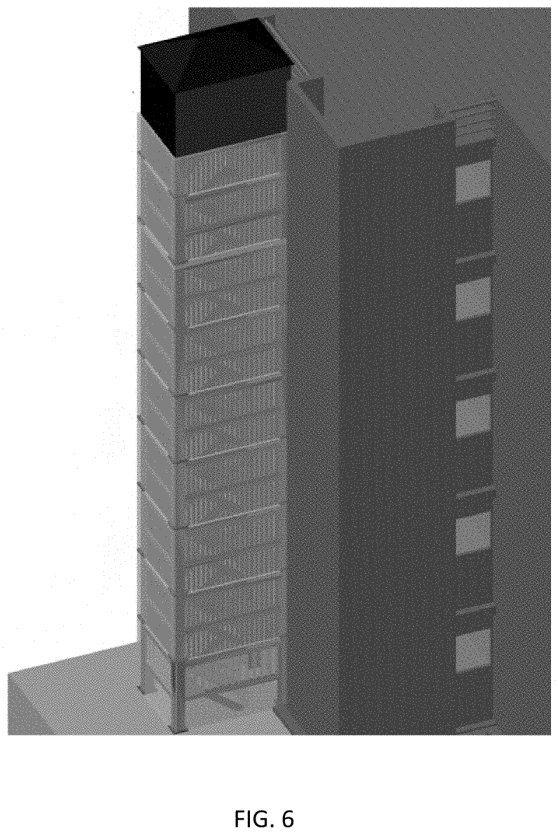

FIG. 4 depicts individual units stacked on top of each other; in cases, one unit per story or floor of a multistory building. In cases, a specialized base pod 401 may be provided that includes extra foundational support for the pods 402 stacked on top of it. In aspects, a container pod 403 containing water, liquid, foam, or other material may be stacked on top of a stack/tower or above other units to provide water, liquid, foam, or other material to the units below. In other cases, water, liquid, foam, or other material may be pumped to the units from above or below, or be stored in individual units. In FIG. 4, it is shown how the individual units may have doors that provide ingress and egress to different floors of a building, for example, and contain stairs that meet and/or connect to each other from unit to unit for climbing or descending. FIG. 5 shows an example of a possible door or emergency exit in one or more units in a stack/tower. FIG. 6 shows an embodiment of a pod per floor of a multi-floor building along with a container, such as a water storage container, on top.

In FIG. 7, an embodiment is depicted of one or more units having a control valve 790 to add sprinkler systems to one or more unit and/or one or more level of the adjacent building.

One skilled in the art will recognize that the disclosed features may be used singularly, in any combination, or omitted based on the requirements and specifications of a given application or design. When an embodiment refers to “comprising” certain features, it is to be understood that the embodiments can alternatively “consist of” or “consist essentially of” any one or more of the features. Other embodiments of the invention will be apparent to those skilled in the art from consideration of the specification and practice of the invention.

It is noted in particular that where a range of values is provided in this specification, each value between the upper and lower limits of that range is also specifically disclosed. The upper and lower limits of these smaller ranges may independently be included or excluded in the range as well. The singular forms “a,” “an,” and “the” include plural referents unless the context clearly dictates otherwise. It is intended that the specification and examples be considered as exemplary in nature and that variations that do not depart from the essence of the invention fall within the scope of the invention. Further, all of the references cited in this disclosure are each individually incorporated by reference herein in their entireties and as such are intended to provide an efficient way of supplementing the enabling disclosure of this invention as well as provide background detailing the level of ordinary skill in the art.

1. A system comprising a plurality of stackable units for connecting to a multistory building, wherein each stackable unit is capable of being stacked and connected vertically to a stackable unit above or below, wherein each stackable unit comprises or is connected to a stairwell, slide, or shoot, wherein upon connecting two stackable units together the stairwells, slides, or shoots meet or line up together, wherein two or more stackable units comprise a plurality of supporting structures, and wherein a first stackable unit of the plurality of stackable units supports a storage unit containing one or more of water, liquid, foam, or other material for transport to a second stackable unit of the plurality of stackable units that is located lower in the plurality of stackable units.

2. The system comprising a plurality of stackable units of claim 1, wherein the plurality of supporting structures comprise legs.

3. The system comprising a plurality of stackable units of claim 1, wherein the stackable units are pre-constructed, pre-fabricated, pre-made, and/or pre-manufactured.

4. The system comprising a plurality of stackable units of claim 1, wherein the storage unit comprises a reservoir for the water, liquid, foam, or other material.

5. The system comprising a plurality of stackable units of claim 1, wherein one or more of the stackable units comprises concrete, metal, steel, treated or reinforced plastic, ceramic, glass, or combinations thereof

6. The system comprising a plurality of stackable units of claim 1, wherein one or more of the stackable units comprises a door or opening to the multistory building and/or the unit above or below.

7. The system comprising a plurality of stackable units of claim 1, wherein one or more of the stackable units comprises a window.

8. The system comprising a plurality of stackable units of claim 1, wherein one or more of the stackable units comprises stairs.

9. The system comprising a plurality of stackable units of claim 1, wherein one or more of the stackable units comprises a slide and/or shoot.

10. The system comprising a plurality of stackable units of claim 1, wherein one or more of the stackable units comprises a sprinkler or sprinkler system.

11. The system comprising a plurality of stackable units of claim 1, wherein one or more of the stackable units comprises a sprinkler shut off valve.

12. The system comprising a plurality of stackable units of claim 1, wherein one or more of the stackable units comprises a hose and/or a hose reel.

13. The system comprising a plurality of stackable units of claim 1, wherein one or more of the stackable units comprises a light.

14. The system comprising a plurality of stackable units of claim 1, wherein one or more of the stackable units comprises an exhaust fan.

15. The system comprising a plurality of stackable units of claim 1, wherein one or more of the stackable units comprises a communication system.

16. The system comprising a plurality of stackable units of claim 1, wherein one or more of the stackable units comprises a hollow connecting member.

17. The system comprising a plurality of stackable units of claim 1, wherein one or more of the stackable units comprises a hollow support and connecting member.

18. The system comprising a plurality of stackable units of claim 1, wherein one or more of the stackable units comprises a stairwell, and wherein a stairwell from an adjacent one of the stackable units above and a stairwell from an adjacent one of the stackable units below meet, connect, and/or line up.

19. The system comprising a plurality of stackable units of claim 1, wherein adjacent stackable units are bolted or otherwise connected or attached to one another.

20. The system comprising a plurality of stackable units of claim 1, wherein multiple stackable units are connected to multiple different floors or stories of the multistory building.

21. The system comprising a plurality of stackable units of claim 1, wherein one or more of the stackable units comprise a door, an exhaust fan, a light, a hollow connecting support member, or combinations thereof.

22. The system comprising a plurality of stackable units of claim 1, wherein one or more of the stackable units is about the same height of a floor or story of the multistory building to which it is attached or adjacent to.

23. The system comprising a plurality of stackable units of claim 1, further comprising two or more stackable units stacked on top of each other.

24. The system comprising a plurality of stackable units of claim 1, wherein one or more of the stackable units lower in a stack of stackable units comprise more support than one or more of the stackable units higher in the stack of stackable units.

25. The system comprising a plurality of stackable units of claim 1, wherein the stackable units are capable of being reinforced with additional support components.
